(19) United States
(12) Patent Application Publication
(10) Pub. No.: US 2011/0153775 A1
(43) Pub. Date: Jun. 23, 2011

(54) INFORMATION RECORDING DEVICE AND INFORMATION RECORDING METHOD

(75) Inventor: Masabumi YANASHIMA, Shibuya-ku (JP)

(73) Assignee: Buffalo Inc., Nagoya-shi (JP)

(21) Appl. No.: 12/970,033

(22) Filed: Dec. 16, 2010

(30) Foreign Application Priority Data
Dec. 18, 2009 (JP) 2009-288429

(51) Int. Cl. G06F 15/16

(52) U.S. Cl. 709/217

(57) ABSTRACT

An information recording device includes storage units and a storage-unit manager for managing the storage units, wherein the storage-unit manager includes a transmitter for responding to the terminal device for each storage unit managed by the storage-unit manager, in response to a request from the terminal device.

### CROSS REFERENCE TO RELATED APPLICATIONS

This application is based upon and claims the benefit of priority from prior Japanese Patent Application No. 2009-288429, filed on Dec. 18, 2009; the entire contents of which are incorporated herein by reference.

### BACKGROUND OF THE INVENTION

1. Field of the Invention

The invention relates to an information recording device including plural storage units and to an information recording method.

2. Description of the Related Art

In recent years, it has become a common practice that plural users share and use through a network those contents accumulated in such an information recording device as a network attached storage (NAS) connected directly with the network. There is proposed a technique which monitors or controls the shared contents in accordance with the Digital Living Network Alliance (DLNA) guidelines (see, for example, Japanese Unexamined Patent Application Publication No. 2008-41120).

The DLNA guidelines define: a digital media server (DMS) to record and store the contents; a digital media player (DMP) to reproduce the contents; and a digital media controller (DMC) for controlling the DMS and the DMP. Once connected to a network, the DMS, the DMP, and the DMC are ready for use. The DMP searches an in-network DMS, and acquires automatically the list of contents available from the searched DMS. If the user chooses a content that he/she wants to watch from the list, the DMS automatically provides the chosen content. Since the DMS thus provides the contents to the user by use of a list, the user need not know where in the DMS a particular content is physically or logically accumulated.

However, if a single DMS (i.e., information recording device) is equipped along with plural removable storage units, such as removable hard disk drives, the administrator cannot identify the removable hard disk drive storing a wanted content.

On the other hand, a technique is proposed according to which the above-mentioned contents are watched and controlled in accordance with the original standards (see, for example, Japanese Unexamined Patent Application Publication No. 2008-289102).

The original standards allow the user to choose between the hard disk drive and the removable media, in which such contents as mentioned above are to be stored.

It is, however, necessary that both the device to record and store the contents and the device to reproduce the contents support the original standards.

### SUMMARY OF THE INVENTION

According to a first aspect of the present invention, there is provided an information recording device which communicates information with a terminal device through a network, and can include a plurality of storage units and a storage-unit manager for managing the storage units, wherein the storage-unit manager includes a transmitter for responding to the terminal device for each storage unit managed by the storage-unit manager, in response to a request from the terminal device.

According to the information recording device, it is possible to identify which of the plural storage units stores an interested content.

According to a second aspect of the present invention, there is provided an information recording device wherein the storage-unit manager includes: a storage-unit-identifier manager for managing each storage unit by use of an identifier; and a stored-content manager for managing contents stored in each storage unit while associating the contents stored in each storage unit with the identifier of the storage unit managed by the storage-unit-identifier manager.

According to a third aspect of the present invention, there is provided an information recording device wherein if the storage unit has no identifier, the storage-unit-identifier manager assigns an optional identifier to the storage unit.

According to the information recording device, identifiers are automatically assigned respectively to the storage units so that it is possible to eliminate human errors, such as incorrect operations by the administrator.

According to a fourth aspect of the present invention, there is provided an information recording device wherein if the storage unit has no identifier, the storage-unit-identifier manager assigns an optional identifier to the storage unit in response to an operation of a user.

According to the information recording device, even if no identifier is automatically assigned to one of the storage units for some reasons, the user can manually set the identifier.

According to an fifth aspect of the present invention, there is provided an information recording device wherein the storage-unit-identifier manager changes the identifier used to identify the storage unit, in response to an operation of the user.

According to the information recording device, the identifiers of the storage units can be changed, resulting in a larger degree of freedom in the settings of the system.

According to a sixth aspect of the present invention, there is provided an information recording device wherein each of the storage units includes a unique database.

According to the information recording device, the malfunction of one database does not affect the other databases.

According to a seventh aspect of the present invention, there is provided an information recording device wherein when each storage unit is formatted, the storage-unit manager creates the database that is unique to the storage unit.

According to the information recording device, each storage unit is initialized automatically so that it is possible to eliminate human errors, such as incorrect operations by the administrator.

According to a eighth aspect of the present invention, there is provided an information recording device wherein the storage-unit manager manages each storage unit by the process that is unique to the storage unit.

According to the information recording device, the malfunction that occurs in one of the processes does not affect the other.

According to a ninth aspect of the present invention, there is provided an information recording device wherein the terminal device and the information recording device communicate information with each other in accordance with DLNA guidelines.

According to a tenth aspect of the present invention, there is provide an information recording method for use with an information recording device which communicates information with a terminal device through a network and can include a plurality of storage units, the information recording method including the steps of responding to the terminal device for each storage unit managed by the storage-unit manager, in response to a request from the terminal device.

### BRIEF DESCRIPTION OF THE DRAWINGS

FIG. 1 is a diagram illustrating the overall configuration of a communication system according to an embodiment of the invention.

FIG. 2 is a block diagram illustrating the configuration of a NAS 20 according to the embodiment of the invention.

FIG. 3 is a flowchart illustrating a first operation of the NAS 20 according to the embodiment of the invention.

FIG. 4 is a flowchart illustrating a second operation of the NAS 20 according to the embodiment of the invention.

FIG. 5 is a flowchart illustrating a third operation of the NAS 20 according to the embodiment of the invention.

FIG. 6 is a flowchart illustrating a fourth operation of the NAS 20 according to the embodiment of the invention.

FIG. 7 is a diagram illustrating a selection screen of a DMP-supporting television receiver 10 according to the embodiment of the invention.

### DETAILED DESCRIPTION OF THE EMBODIMENTS

An embodiment of the invention will be described below in referring to the drawings. Description will be given specifically of the following points: (1) the overall configuration of a communication system; (2) the configurations of a Network Attached Storage (NAS); (3) the operations of the NAS; (4) the advantageous effects; and (5) other embodiments. Throughout the drawings of the embodiments described below, identical or similar constituents are denoted by the same or similar reference numerals. In a communication system of this embodiment, communication is performed in accordance with the DLNA guidelines.

### (1) Overall Configuration of Communication System

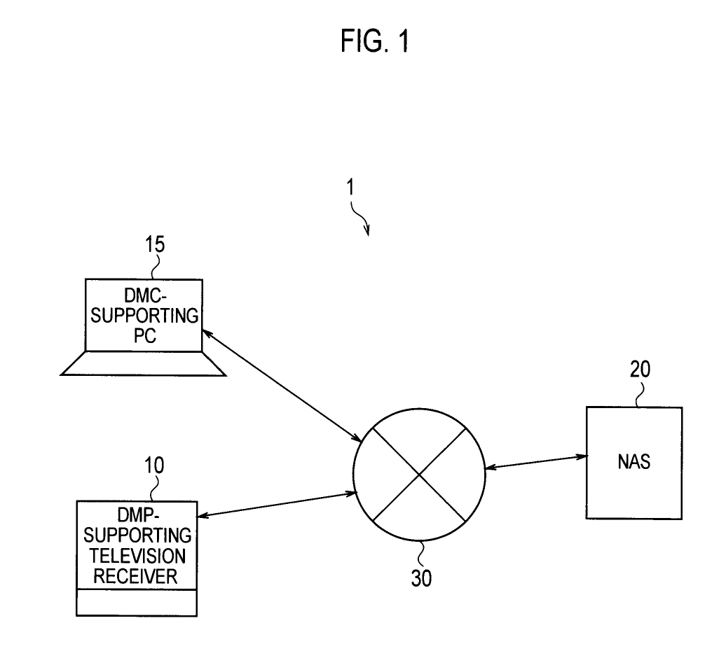

FIG. 1 is a diagram illustrating the overall configuration of a communication system 1 according to an embodiment of the invention.

As FIG. 1 shows, the communication system 1 includes a DMP-supporting television receiver 10, a DMC-supporting PC 15, a Network Attached Storage (NAS) 20, and a network 30.

The DMP-supporting television receiver 10 requests, through the network 30, contents, such as a video content and an audio content, accumulated in the NAS 20. The DMP-supporting television receiver 10 receives the contents from the NAS 20, and displays the received content.

The DMC-supporting PC 15 performs various settings for the NAS 20 through the network 30. Note that the DMC-supporting PC 15 includes a portable terminal device or the like.

The NAS 20 transmits the content requested by the DMP-supporting television receiver 10 to the DMP-supporting television receiver 10 through the network 30. In addition, the NAS 20 performs various settings requested by the DMC-supporting PC 15, through the network 30. Note that the NAS 20 is equipped along with two removable hard disk drives. The two removable hard disk drives are managed respectively by Digital Media Servers (DMSs) through independent processes.

The network 30 is a Local Area Network (LAN).

### (2) Configuration of Network Attached Storage (NAS)

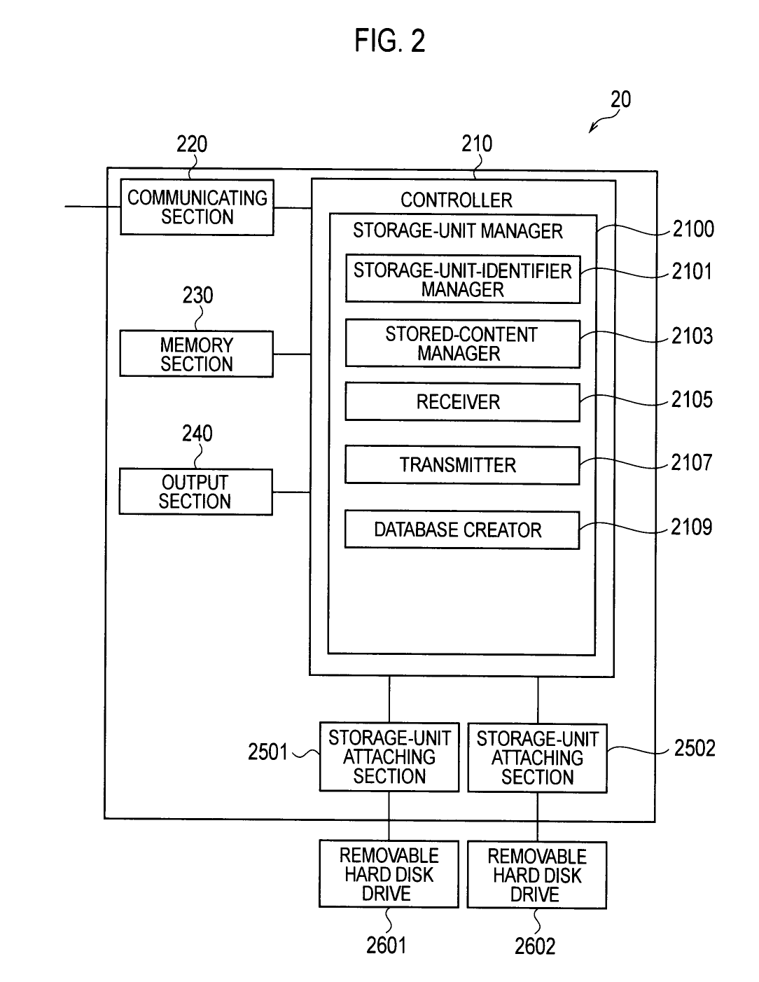

FIG. 2 is a block diagram illustrating the configuration of the NAS 20 according to the embodiment of the invention.

The NAS 20 shown in FIG. 2 provides such contents as video contents and audio contents, to the DMP-supporting television receiver 10 in the communication system 1. The NAS 20 includes a controller 210, a communicating section 220, a memory section 230, an output section 240, a storage-unit attaching section 2501, a storage-unit attaching section 2502, a removable hard disk drive 2601, and a removable hard disk drive 2602.

The controller 210 is composed of a CPU, for example, and controls the variety of functions that the NAS 20 has.

The communicating section 220 communicates either with the DMP-supporting television receiver 10 or with the DMC-supporting PC 15 through the network 30.

The memory section 230 is a NAND Flash Memory, for example, and stores various kinds of information to be used in the control performed by the NAS 20. To put it concretely, the memory section 230 stores an OS program, a Digital Media Server (DMS) program, and the like.

The output section 240 is a speaker or an LED, for example, and notifies the administrator of, for example, the state of executing exceptional processes.

Both the storage-unit attaching section 2501 and the storage-unit attaching section 2502 are used to attach both the removable hard disk drive 2601 and the removable hard disk drive 2602 to the NAS 20. In this embodiment, the removable hard disk drive 2601 is attached to the storage-unit attaching section 2501 while the removable hard disk drive 2602 is attached to the storage-unit attaching section 2502. They are always attached together to the storage-unit attaching section. In addition, both the removable hard disk drive 2601 and the removable hard disk drive 2602 have already been formatted.

The controller 210 includes a storage-unit manager 2100.

The storage-unit manager 2100 manages both the removable hard disk drive 2601 attached to the storage-unit attaching section 2501 and the removable hard disk drive 2602 attached to the storage-unit attaching section 2502. In addition, when the NAS 20 is booted, the storage-unit manager 2100 executes the DMSs that correspond to the respective removable hard disk drives and are managed in accordance with independent processes.

In this embodiment, two DMSs are executed. In addition, if no shared folder to manage free contents is formed in any of the removable hard disk drive 2601 and the removable hard disk drive 2602, the storage-unit manager 2100 creates such a shared folder. In addition, the storage-unit manager 2100 may notify the DMP-supporting television receiver 10, by use of the DMSs, of the fact that the connection of the NAS 20 to the communication system 1 is completely established. In addition, if neither the storage-unit attaching section 2501 nor the storage-unit attaching section 2502 has a removable hard disk drive attached thereto, the storage-unit manager 2100 may notify, by use of the output section 240, the administrator of the state of executing the exceptional process or the like.

The storage-unit manager 2100 includes a storage-unit-identifier manager 2101, a stored-content manager 2103, a receiver 2105, a transmitter 2107, and a database creator 2109. Note that the storage-unit manager 2100 includes a storage-unit-identifier manager 2101, a stored-content manager 2103, a receiver 2105, a transmitter 2107, and a database creator 2109 with respect to each of the DMSs which correspond to the respective removable hard disk drives and are managed in accordance with independent processes. In this embodiment, the DMS that corresponds to the removable hard disk drive 2601 is referred to as a DMS1 whereas the DMS that corresponds to the removable hard disk drive 2602 is referred to as a DMS2.

The storage-unit-identifier manager 2101 of the DMS1 manages a HDD (Hard Disk Drive)-name storing file to which the HDD name is written, the HDD-name storing file being stored in the removable hard disk drive 2601. If the removable hard disk drive 2601 stores no HDD-name storing file, the storage-unit-identifier manager 2101 of the DMS1 creates a HDD-name storing file to which a default HDD-name is written and stores the created HDD-name storing file in the removable hard disk drive 2601. In addition, if the removable hard disk drive 2601 stores no HDD-name storing file for some reason, or if the removable hard disk drive 2601 has stored a HDD-name storing file, the storage-unit-identifier manager 2101 of the DMS1 creates or updates a HDD-name storing file to which a HDD-name is written, the HDD-name being set by the DMC-supporting PC 15 in accordance with the user's operation, and stores the created HDD-name storing file in the removable hard disk drive 2601. How the DMC-supporting PC 15 sets or changes the HDD-name will be described later. The storage-unit-identifier manager 2101 of the DMS 2 executes similar processing for the removable hard disk drive 2602.

If the removable hard disk drive 2601 has no copyright-protected-content directory created therein, the copyright-protected-content directory being used to manage copyright-protected contents, the stored-content manager 2103 of the DMS1 creates such a copyright-protected-content directory. The stored-content manager 2103 of the DMS1 manages the stored content of the removable hard disk drive 2601 in association with the HDD-name storing file managed by the storage-unit-identifier manager 2101 of the DMS1. Note that the stored content of the removable hard disk drive 2601 specifically refers to metadata on the contents stored either in the shared folder or in the copyright-protected-content directory of the removable hard disk drive 2601. The metadata are stored in the database in the removable hard disk drive 2601. Detailed description of the database will be given later. In addition, the stored-content manager 2103 of the DMS1 stores a new copyright-protected content in the copyright-protected-content directory. In this event, the stored-content manager 2103 of the DMS1 stores metadata on the new content. In addition, the stored-content manager 2103 of the DMS1 stores metadata on the free contents stored in the shared folder. Note that the stored-content manager 2103 of the DMS2 executes similar processes for the removable hard disk drive 2602.

In accordance with the user's operation, the receiver 2105 of the DMS1 receives, through the network 30, a content-acquisition request that is requested by the DMP-supporting television receiver 10, a HDD-name changing request that is requested by the DMC-supporting PC 15 for changing the name of the removable hard disk drive 2601, and the like. Note that the receiver 2105 of the DMS2 executes similar processing for the removable hard disk drive 2602.

The transmitter 2107 of the DMS1 transmits responses to the requests received by the receiver 2105 of the DMS1, to the DMP-supporting television receiver 10 or to the DMC-supporting PC 15 through the network 30. Note that the transmitter 2107 of the DMS2 executes similar processing for the removable hard disk drive 2602.

If the removable hard disk drive 2601 has no database formed therein, the database creator 2109 of the DMS1 creates a database in the removable hard disk drive 2601. Note that the data to be stored in the database are metadata on the genre, the aspect ratio, the length, and the like of the contents to be stored in the removable hard disk drive 2601. The contents themselves are not stored in the database but stored either in the shared folder or in the copyright-protected-content directory of the removable hard disk drive 2601. Note that the database creator 2109 of the DMS2 executes similar processing for the removable hard disk drive 2602.

### (3) Operations of NAS

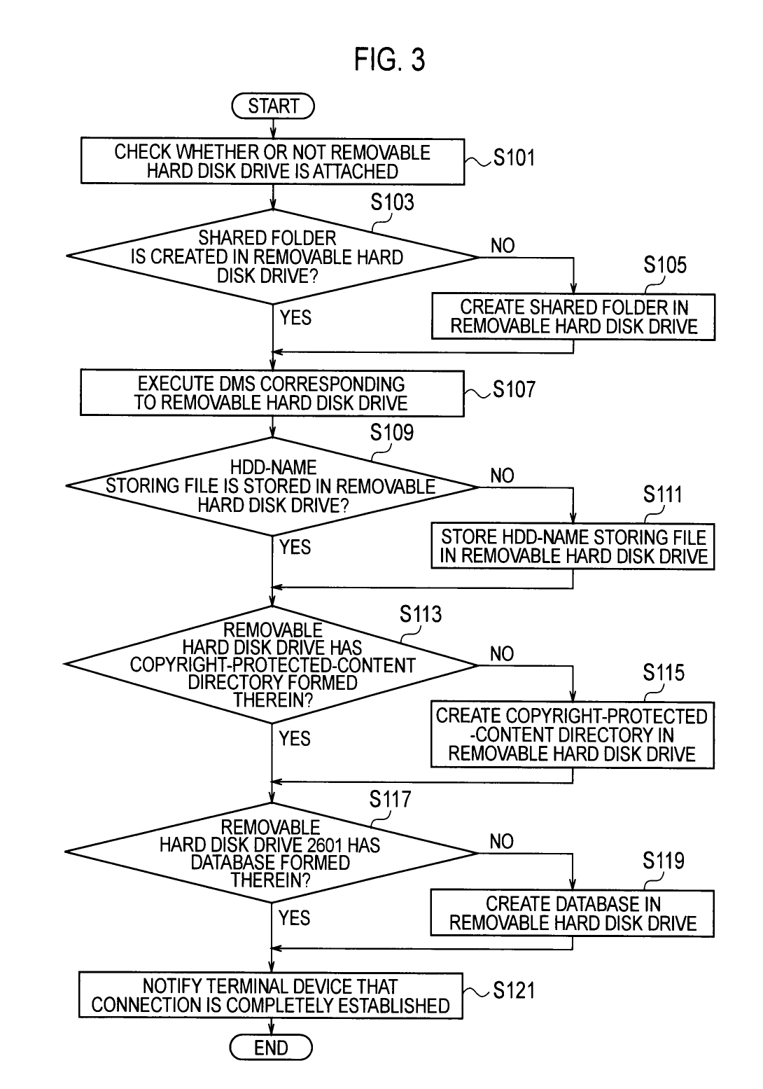

Next, the operations of the NAS 20 will be described. FIGS. 3 to 6 are flowcharts illustrating the operations of the NAS 20.

Firstly, the operation of the NAS 20 at the time of booting will be described in referring to FIG. 3.

In step S101, the storage-unit manager 2100 checks whether or not the removable hard disk drive 2601 is attached to the storage-unit attaching section 2501 and whether or not the removable hard disk drive 2602 is attached to the storage-unit attaching section 2502. Note that, if neither the storage-unit attaching section 2501 nor the storage-unit attaching section 2502 has a removable hard disk drive attached thereto, the storage-unit manager 2100 may notify, by use of the output section 240, the administrator of the state of executing the exceptional processing or the like.

In step S103, the storage-unit manager 2100 checks whether or not a shared folder is created in the removable hard disk drive 2601 attached to the storage-unit attaching section 2501 and whether or not a shared folder is created in the removable hard disk drive 2602 attached to the storage-unit attaching section 2502.

If a shared folder is not formed in the removable hard disk drive 2601 or 2602, the storage-unit manager 2100 creates, in step S105, a shared folder in the removable hard disk drive 2601 or 2602 that has no shared folder formed therein.

If both the removable hard disk drives 2601 and 2602 have shared folders formed therein, or after the creation of the shared folder in step S105, the storage-unit manager 2100 executes, in step S107, the DMSs (Digital Media Servers) corresponding to the removable hard disk drives 2601 and 2602 as the DMS1 and the DMS2 respectively, and managed by independent processes.

In step S109, the storage-unit-identifier manager 2101 of the DMS1 checks whether or not a HDD-name storing file is stored in the removable hard disk drive 2601.

If the removable hard disk drive 2601 has no HDD-name storing file stored therein, the storage-unit-identifier manager 2101 of the DMS1 creates, in step S111, a HDD-name storing file to which a default HDD-name is written and stores the created HDD-name storing file in the removable hard disk drive 2601. Note that the storage-unit-identifier manager 2101 of the DMS2 executes similar processing for the removable hard disk drive 2602.

If the removable hard disk drive 2601 has a HDD-name storing file stored therein, or after creating and storing the default HDD-name storing file in step S111, the stored-content manager 2103 of the DMS1 checks, in step S113, whether or not the removable hard disk drive 2601 has a copyright-protected-content directory formed therein.

If the removable hard disk drive 2601 has no copyright-protected-content directory formed therein, the stored-content manager 2103 of the DMS1 creates a copyright-protected-content directory in the removable hard disk drive 2601 in step S115. Note that the stored-content manager 2103 of the DMS2 executes similar processing for the removable hard disk drive 2602.

If the removable hard disk drive 2601 has a copyright-protected-content directory formed therein, or after the creation of the copyright-protected-content directory in step S115, the database creator 2109 of the DMS1 checks whether or not the removable hard disk drive 2601 has a database formed therein in step S117.

If the removable hard disk drive 2601 has no database formed therein, the database creator 2109 of the DMS1 creates a database in the removable hard disk drive 2601 in step S119. Note that the database creator 2109 of the DMS2 executes similar processing for the removable hard disk drive 2602.

If the removable hard disk drive 2601 has a database formed therein, or after the creation of the database in step S119, the transmitter 2107 of the DMS1 corresponding to the removable hard disk drive 2601 notifies, in step S121, the DMP-supporting television receiver 10 of the fact that the DMS1 is executed and that the connection to the communication system 1 is completely established. Note that the DMS1 performs the notification by the “NOTIFY” function of the Universal Plug and Play (UPnP) on which the communication procedure between devices is based in the DLNA guidelines. Note that the transmitter 2107 of the DMS2 executes similar processing for the removable hard disk drive 2602.

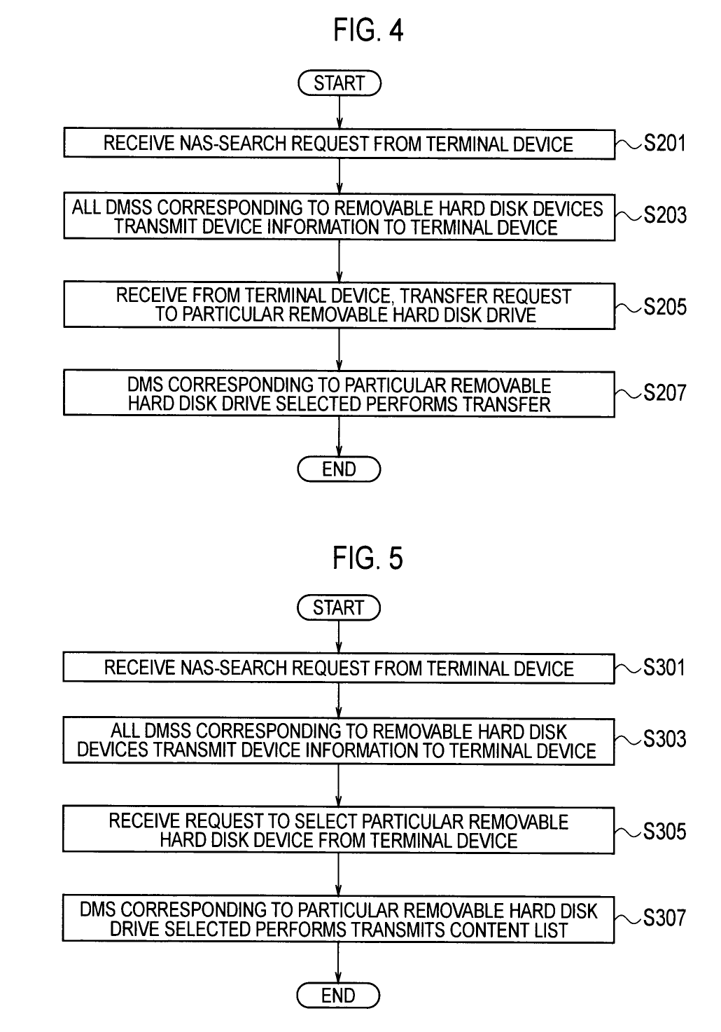

Next, operations of transferring contents after the booting of the NAS 20 will be described by referring to FIG. 4.

In step S201, both the receiver 2105 of the DMS1 corresponding to the removable hard disk drive 2601 and the receiver 2105 of the DMS2 corresponding to the removable hard disk drive 2602 receive, from the DMP-supporting television receiver 10 through the network 30, NAS-search requests which are performed by the “M-SEARCH” function of the UPnP.

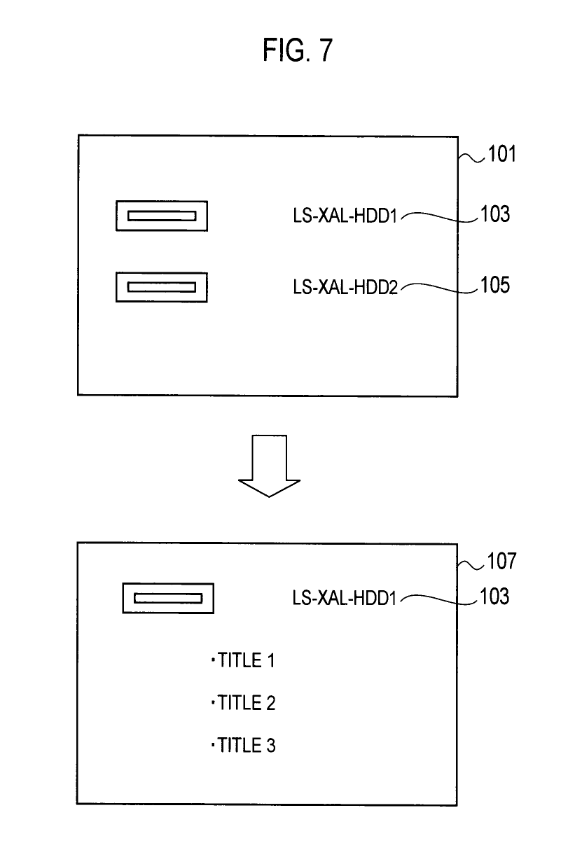

In step S203, the transmitter 2107 of the DMS1 corresponding to the removable hard disk drive 2601 attached to the storage-unit attaching section 2501 transmits the response to the NAS-search request to the DMP-supporting television receiver 10 through the network 30. To put it concretely, the transmitter 2107 of the DMS1 acquires the HDD-name from the HDD-name storing file stored in the removable hard disk drive 2601. The transmitter 2107 of the DMS1 then transmits, as device information (UPnP Device Description) of the DMS1, the acquired HDD-name, a Unique Device Name (UDN), and a HTTP port number to the DMP-supporting television receiver 10. The UDN is an arbitrarily determined ID that does not overlap those of other devices, and is used for the identification on the UPnP. The HTTP port number is arbitrarily determined so as not to overlap those of other devices. Note that the transmitter 2107 of the DMS2 corresponding to the removable hard disk drive 2602 attached to the storage-unit attaching section 2502 executes similar processing for the removable hard disk drive 2602. Note that a HDD-name 103 shown on a screen 101 of FIG. 7 represents the removable hard disk drive 2601 attached to the storage-unit attaching section 2501, and the HDD-name 103 is displayed on the DMP-supporting television receiver 10 as an element of a list. In addition, a HDD-name 105 represents the removable hard disk drive 2602 attached to the storage-unit attaching section 2502, and the HD-name 105 is displayed on the DMP-supporting television receiver 10 as an element of the list. The list is created on the basis of the device information transmitted from the transmitter 2107 of the DMS1 corresponding to the removable hard disk drive 2601 and the transmitter 2107 of the DMS2 corresponding to the removable hard disk drive 2602. The DMP-supporting television receiver 10 thus receives two responses from the NAS 20. Note that the transmitter 2107 of each DMS responds by use of the response of the “M-SEARCH” function of the UPnP.

In step S205, the receiver 2105 of the DMS1 corresponding to the removable hard disk drive 2601 receives copyright-protected-content data as a transfer request, from the DMP-supporting television receiver 10 through the network 30, the copyright-protected-content data being transferred based on the UDN and the HTTP port number chosen by the user and corresponding to the HDD-name 103 shown on the screen 101 shown in FIG. 7. Note that both the DMP-supporting television receiver 10 and the NAS 20 support the DTCP-IP, which is a technical standard to transfer contents protected by a copyright-protection technique. The DMP-supporting television receiver 10 performs the request by the function of transferring and accumulating the copyright-protected data according to the DTCP-IP.

In step S207, the stored-content manager 2103 of the DMS1 corresponding to the removable hard disk drive 2601 stores the transferred copyright-protected-content data received by the receiver 2105 of the DMS1 in the copyright-protected-content directory in the removable hard disk drive 2601 as a new copyright-protected content, through the network 30. In this event, the stored-content manager 2103 of the DMS1 stores the metadata of the content in the database in the removable hard disk drive 2601. Note that the storing of the metadata of the content in the database in the removable hard disk drive 2601 may be performed by use of the DMC-supporting PC 15, either by the user's operation of immediately storing the metadata or by the setting of periodical batch execution. On the other hand, free contents to be stored respectively in the shared folders in the removable hard disk drive 2601 and the removable hard disk drive 2602 are stored in the shared folders not by processes of the respective DMSs but by an OS-related process of the NAS 20. In this event, the OS-related process of the NAS 20 stores the metadata of the free contents in the database in the removable hard disk drive 2601 and in the database in the removable hard disk drive 2602. Note that the storing of the metadata of the contents in the database in the removable hard disk drive 2601 and in the database in the removable hard disk drive 2602 may be performed by use of the DMC-supporting PC 15, either by the user's operation of immediately storing the metadata or by the setting of periodical batch execution. Note that the transferring of contents to the removable hard disk drive 2601 of the DMS1 has been described in this embodiment, but the transferring of contents to the removable hard disk drive 2602 of the DMS2 is performed in a similar procedure.

Next, the operation of choosing a content after the booting of the NAS 20 will be described by referring to FIG. 5.

Steps S301 and S303 are similar to steps S201 and S203 in FIG. 4, respectively.

In step S305, the receiver 2105 of the DMS1 corresponding to the removable hard disk drive 2601 receives a content-list request from the DMP-supporting television receiver 10 through the network 30, the content-list request being chosen by the user and based on the UDN and the HTTP-port number corresponding to the HDD-name 103 on the screen 101 shown in FIG. 7. Note that the DMP-supporting television receiver 10 performs the request by the “SOAPACTION” function of the UPnP.

In step S307, the transmitter 2107 of the DMS1 corresponding to the removable hard disk drive 2601 attached to the storage-unit attaching section 2501 transmits to the DMP-supporting television receiver 10 through the network 30 a response to the content-list request. To put it concretely, the transmitter 2107 of the DMS1 transmits the corresponding metadata to be stored in the database in the removable hard disk drive 2601 as the content information, to the DMP-supporting television receiver 10. Note that the screen 107 in FIG. 7 is the display of the list of the content on the DMP-supporting television receiver 10. The content list is stored in the removable hard disk drive 2601 and has the HDD-name 103. The content list is created only from the content information transmitted from the transmitter 2107 of the DMS1 corresponding to the removable hard disk drive 2601. In fact, the DMP-supporting television receiver 10 receives a single response from the NAS 20. Note that the transmitter 2107 of the DMS1 performs the response by the response of the “SOAPACTION” of the UPnP. Note that the acquisition of the content list in the removable hard disk drive 2601 by the DMS1 has been described in this embodiment, but the acquisition of the content list in the removable hard disk drive 2602 by the DMS2 is performed by a similar procedure.

FIG. 7 exemplarily illustrates a two-layer screen including both the screen 101 and the screen 107. The screen 101 displays a list including both the HDD-name 103 corresponding to the removable hard disk drive 2601 attached to the storage-unit attaching section 2501 and the HDD-name 105 corresponding to the removable hard disk drive 2602 attached to the storage-unit attaching section 2502. The screen 107 also displays the list of the contents stored in the removable hard disk drive 2601. There is no limitation, however, to the number of the layers except that the screen 101 must be displayed.

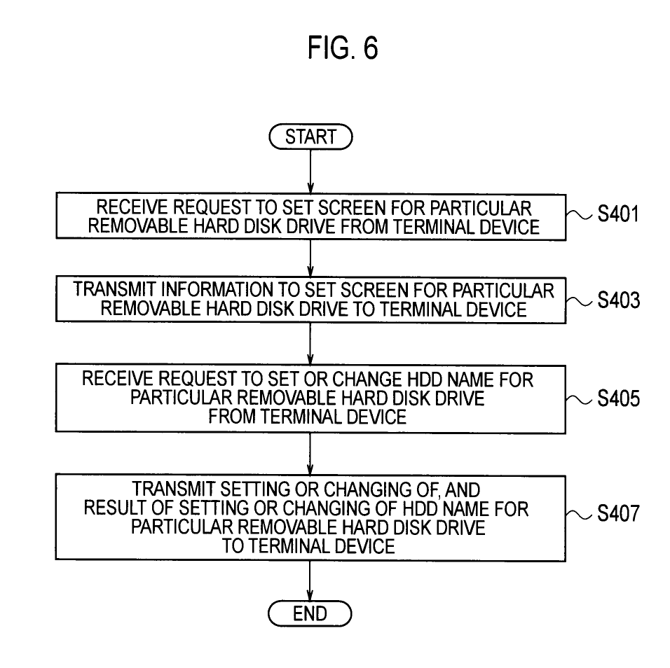

Next, description will be made, by referring to FIG. 6, of the operation of setting or changing the HDD-name of the removable hard disk drive where no HDD-name storing file is stored for some reason, or where a HDD-name storing file has already been stored. In this embodiment, a process of the DMS1 that corresponds to the removable hard disk drive 2601 performs the setting or changing of the HDD-name of the removable hard disk drive 2601. In addition, a process of the DMS2 that corresponds to the removable hard disk drive 2602 performs the setting or changing of the HDD-name of the removable hard disk drive 2602. However, a setting program managed by a unique process may perform the setting or changing of the HDD-name of the removable hard disk drive.

In step S401, the receiver 2105 of the DMS1 corresponding to the removable hard disk drive 2601 receives, from the DMC-supporting PC 15 through the network 30, a request for information of the setting screen for the removable hard disk drive 2601 in response to an operation of the user.

In step S403, the transmitter 2107 of the DMS1 transmits, as a response, the information of the setting screen for the removable hard disk drive 2601 to the DMC-supporting PC 15 through the network 30.

In step S405, the receiver 2105 of the DMS1 receives, from the DMC-supporting PC 15 through the network 30, a request for setting or changing the HDD-name of the removable hard disk drive 2601 in response to an operation of the user.

In step S407, using the HDD-name included in the request for setting or changing the HDD-name received by the receiver 2105 of the DMS1, the storage-unit-identifier manager 2101 of the DMS1 creates or updates the HDD-name storing file, and stores the new HDD-name storing file in the removable hard disk drive 2601. The transmitter 2107 of the DMS1 transmits, as a response, the result of setting or changing the HDD-name to the DMC-supporting PC 15 through the network 30. Note that the setting or changing of the HDD-name of the removable hard disk drive 2601 by the DMS1 has been described in this embodiment, but the setting or changing of the HDD-name of the removable hard disk drive 2602 by the DMS2 is performed by a similar procedure.

### (4) Advantageous Effects

In the embodiment of the invention, two removable hard disk drives are included in the NAS 20, and the NAS 20 manages each of the contents stored in the two removable hard disk drives independently.

According to the NAS 20, it is not necessary for both of the NAS 20 and either the DMP-supporting television receiver 10 or the DMC-supporting PC 15 support the original standards. Only by expanding the functions of the NAS 20 and by making both the NAS 20 and either the DMP-supporting television receiver 10 or the DMC-supporting PC 15 support the existing DLNA guidelines, it is possible to identify that one of the two removable hard disk drives which accumulates a particular content.

In addition, since the DMSs corresponding respectively to the two removable hard disk drives are managed by independent processes, the malfunction of one of the two DMSs does not affect the removable hard disk drive of the other DMS.

In addition, since the NAS 20 automatically stores the default HDD-names of the removable hard disk drives and creates the databases in the removable hard disk drives, it is possible to eliminate human errors, such as incorrect operations by the administrator.

In addition, the fact that the HDD-name of each removable hard disk drive is changeable gives a high degree of freedom in the system setting.

### (5) Other Embodiments

The invention has been described by use of an embodiment. However, it should not be understood that the description and drawings which constitute part of this disclosure limit the present invention. From this disclosure, various alternative embodiments, examples, and operation techniques will be easily found by those skilled in the art.

The above-described embodiment is based on a case where the DLNA guidelines and the DTCP-IP are used, but the invention can be applied to cases where other guidelines or standards that allow similar processing are used.

In addition, the storage units of the invention are not necessarily removable hard disk drives. For example, various other storage media, such as optical drives, may be used=instead.

In addition, the number of storage units to be used simultaneously in the invention is not necessarily two. The invention may include only a single storage unit, or may also include three or more storage units.

In addition, each storage unit of the invention is not necessarily removable. Each storage unit may be a fixed one as long as two or more such fixed storage units are used simultaneously.

In addition, the network 30 in the above-described embodiment is a LAN, but the network 30 may be a network of another type, such as a network via a Wide Area Network (WAN).

In addition, since two removable hard disk drives are used in the above-described embodiment, two DMSs are executed and the two removable hard disk drives are managed by independent processes, respectively. However, the same goes for other cases where the number of the removable hard disk drives is not two. For example, if only a single removable hard disk drive is used, only a single DMS is executed and the removable hard disk drive is managed by its own process.

As described above, it should be understood that the present invention naturally includes various embodiments which are not described herein. Accordingly, the present invention should be limited only by the matters to define the invention in the scope of claims regarded as appropriate based on the description.

According to the information recording device and the information recording method of the invention, it is possible to identify that one of plural storage units which accumulates a particular content. Accordingly, the information recording device and the information recording method of the invention prove useful as an information recording device and an information recording method.

What is claimed is:

1. An information recording device which communicates information with a terminal device through a network, comprising:
a plurality of storage units; and
a storage-unit manager for managing the storage units,
wherein the storage-unit manager includes a transmitter for responding to the terminal device for each storage unit managed by the storage-unit manager, in response to a request from the terminal device.

2. The information recording device according to claim 1,
wherein the storage-unit manager includes:
a storage-unit-identifier manager for managing each storage unit by use of an identifier; and
a stored-content manager for managing the contents stored in each storage unit while associating the contents stored in each storage unit with the identifier of the storage unit managed by the storage-unit-identifier manager.

3. The information recording device according to claim 2, wherein if the storage unit has no identifier, the storage-unit-identifier manager assigns an optional identifier to the storage unit.

4. The information recording device according to claim 2, wherein if the storage unit has no identifier, the storage-unit-identifier manager assigns an optional identifier to the storage unit in response to an operation of a user.

5. The information recording device according to claim 2, wherein the storage-unit-identifier manager changes the identifier used to identify the storage unit, in response to an operation of the user.

6. The information recording device according to claim 1, wherein each of the storage unit includes a unique database.

7. The information recording device according to claim 1, wherein when each storage unit is formatted, the storage-unit manager creates the database that is unique to the storage unit.

8. The information recording device according to claim 1, wherein the storage-unit manager manages each storage unit by a process that is unique to the storage unit.

9. The information recording device according to claim 1, wherein the terminal device and the information recording device communicate information with each other in accordance with DLNA guidelines.

10. An information recording method for use with an information recording device which communicates information with a terminal device through a network and can include a plurality of storage units, the information recording method comprising the steps of responding to the terminal device for each storage unit managed by the storage-unit manager, in response to a request from the terminal device.
